(19) United States
(12) Patent Application Publication
(10) Pub. No.: US 2009/0319570 A1
(43) Pub. Date: Dec. 24, 2009

(54) CONSOLIDATING DUPLICATE ITEM IMAGES USING AN IMAGE IDENTIFIER

(76) Inventor: Mahesh Subramanian, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/145,313

(22) Filed: Jun. 24, 2008

(51) Int. Cl. G06F 17/30

(52) U.S. Cl. 707/104.1; 707/E17.009

(57) ABSTRACT

In some example embodiments, a system and method are illustrated to link item images to item listings. The system and method include receiving an item listing and an image for the item listing from a user device. The system and method include assigning an image identifier to the image received from the user device. The image identifier may be identical or substantially identical for the same or similar images and unique for different images. The system and method include comparing the image identifier with one or more existing image identifiers. The system and method further include linking the received item listing to an image according to a result of the comparing. In some example embodiments, the system and method include receiving the image identifier from the user device and determining whether to receive the image for the item listing from the user device according to the result of the comparing.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be described below and in the drawings that form a part of this document: Copyright©2008, eBay Inc. All Rights Reserved.

### TECHNICAL FIELD

Example embodiments relate generally to the technical field of algorithms and programming and, in an example, to the uploading and linking of item images to manage item listings.

### BACKGROUND

Image hashing is mapping an image to a short binary string. An image hash function extracts a fixed-length bit string from a given image. The extracted bit string has been used in various cryptographic applications for use in digital signatures to authenticate a message being sent so that a recipient of the message can verify its source. The image hash function may be used in multimedia applications to index, search and sort images in multimedia databases.

### BRIEF DESCRIPTION OF THE DRAWINGS

Some embodiments are illustrated by way of example and not limitation in the figures of the accompanying drawings in which:

FIG. 1 is a diagram of a computer system for uploading and managing item listings in accordance with an example embodiment.

FIG. 2A is a diagram of a computer system for managing item listings in accordance with an example embodiment.

FIG. 2B is a diagram of a computer system for managing item listings in accordance with an example embodiment.

FIG. 3 is a diagram of a computer system for uploading item listings in accordance with an example embodiment.

FIG. 4 is a flow chart illustrating a method used to manage item listings in accordance with an example embodiment.

FIG. 5 is a flow chart illustrating a method used to manage existing item images in accordance with an example embodiment.

FIG. 6 is a flow chart illustrating a method used to receive an item listing from a user device in accordance with an example embodiment.

FIG. 7 is a flow chart illustrating a method used to upload an item listing to a host device in accordance with an example embodiment.

FIG. 8 is a diagram illustrating a data structure for an item listing in accordance with an example embodiment.

FIG. 9 is a diagram showing an example computer system that executes a set of instructions to perform any one or more of the methodologies discussed herein.

### DETAILED DESCRIPTION

In some example embodiments, a system and method are illustrated to link item images to item listings. The system and method include receiving an item listing and a tentative image for the item listing from a user device. The system and method include assigning an image identifier to the tentative image received from the user device. The image identifier may be identical or substantially identical for the same or similar images and unique for different images. The system and method include comparing the image identifier with one or more image identifiers for existing images for existing item listings. The system and method further include linking the received item listing to the tentative image according to a result of the comparing.

In some example embodiments, a system and method are illustrated to receive item images for item listings. The system and method include receiving an image identifier associated with an image for an item listing from a user device. The image identifier may be identical or substantially identical for the same or similar images and unique for different images. The system and method include comparing the image identifier received from the user device with one or more image identifiers for existing images for existing item listings. The system and method further include determining whether to receive the image for the item listing from the user device according to a result of the comparing.

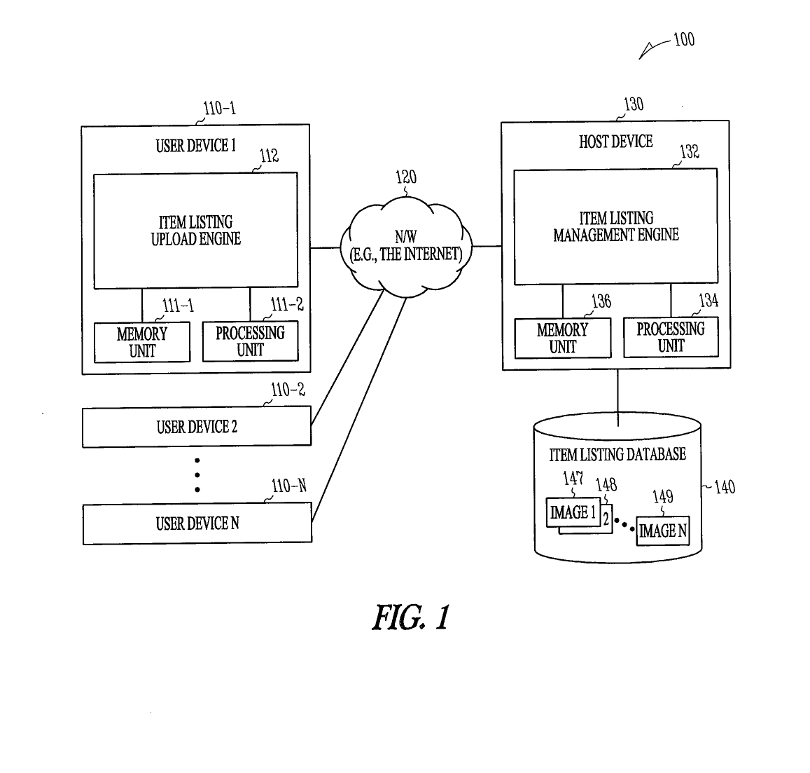

In some example embodiments, an image identifier for an item listing may be generated as a function of a hash algorithm. For example, conventional cryptographic hashing algorithms such as message digest 5 (MD5) and secure hash algorithm 1 (SHA-1) may be used to produce the image identifier. These hashing functions may be sensitive to the message (e.g., changing even one bit of the input may change the output). Multimedia data such as digital images, however, may go through various manipulations such as compression, enhancement, cropping, and scaling. An image hash function thus may take into account the changes in a visual domain and produce hash values based on the image's visual appearance. In some example embodiments, therefore, an image hash function may be used to produce the identical or substantially identical hash value with high probability for perceptually identical or similar images, while producing unique or substantially independent hash values for perceptually different images. Such a hash function would be useful in identifying images in databases, in which the image possibly undergoes incidental changes (such as compression and format changes, common signal processing operations, scanning or watermarking). Such a hash function would also be useful in identifying different but substantially similar images for similar items. More detailed information about sharing duplicate images for item listings using image identifiers is given below using FIGS. 1-9.

FIG. 1 is a diagram of a computer system for uploading and managing item listings 100 in accordance with an example embodiment. Illustrated in FIG. 1 are user devices 110-1 through 110-N, a network 120, a host device 130 and item listing database 140. Each of the user devices (e.g., 110-1) may have an item listing upload engine 112, a memory unit 111-1 and a processing unit 111-2. Although descriptions are given only for the item listing upload engine 112, the memory unit 111-1 and the processing unit 111-2 of the user device 1 (110-1), it is noted that each of the other user devices (e.g., user device 2 (110-2) through user device N (110-N)) may have corresponding elements with the same functionality.

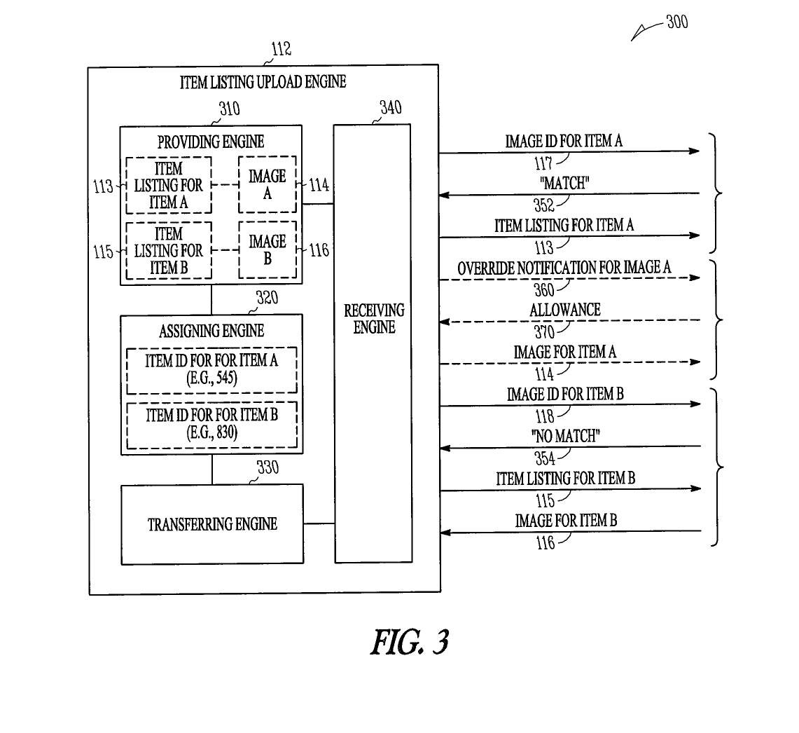

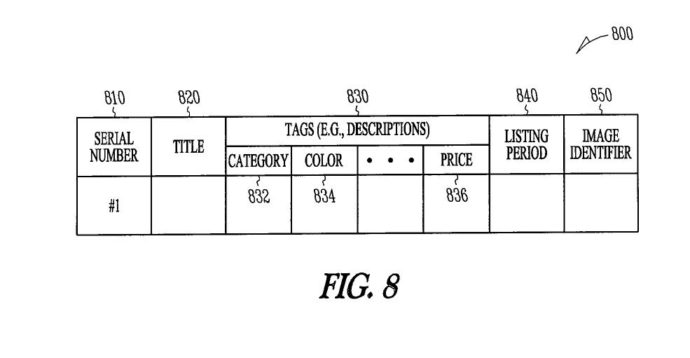

The item listing upload engine 112 may receive an item listing for an item and an image for the item listing from a user (not shown in FIG. 1). The item may be a good (e.g., iPod Nano) or service (e.g., golf lesson) that may be transacted (e.g., exchanging, sharing information about, buying, selling, making a bid, etc.). The item listing for the item may be a detailed description for the item including a title, category (e.g., electronics, sporting goods, books, antiques, etc.), other tag information (e.g., color, size, period of use if the item is a used item, etc.). The item listing may further include a listing period for the item listing to be displayed. The item listing may be linked to an item image via an image identifier later in the host device 130. (More detailed explanation about a data structure of the item listing is given below using FIG. 8.) The memory unit 111-1 may store the item listing and the image for the item listing received from the user for further processing by the processing unit 111-2. If the item listing and/or the image for the item listing are prepared, the item listing upload engine 112 may transfer (e.g., upload) both the item listing and the image for the item listing to the host device 130 via the network 120. The network 120 may be the Internet, Local Area Network (LAN), Wide Area Network (WAN) or any of other suitable networks. In some example embodiments, the image for the item listing may not be transferred to the host device 130. More detailed explanation about the item listing upload engine 112 is given below using FIG. 3.

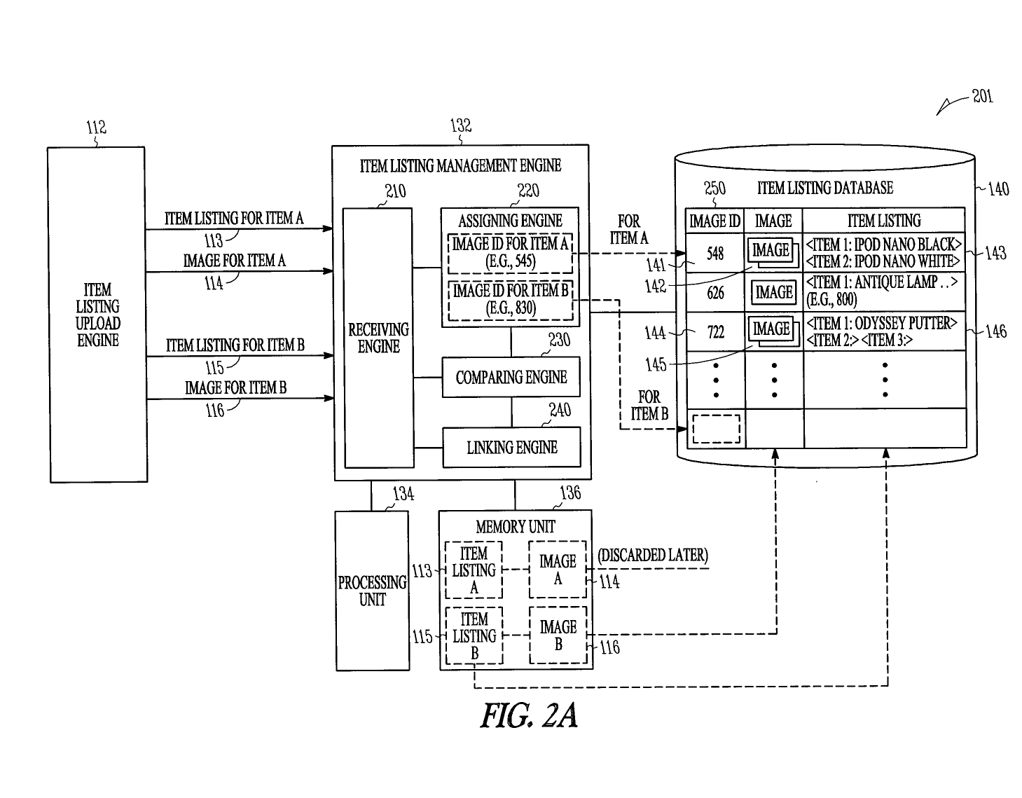

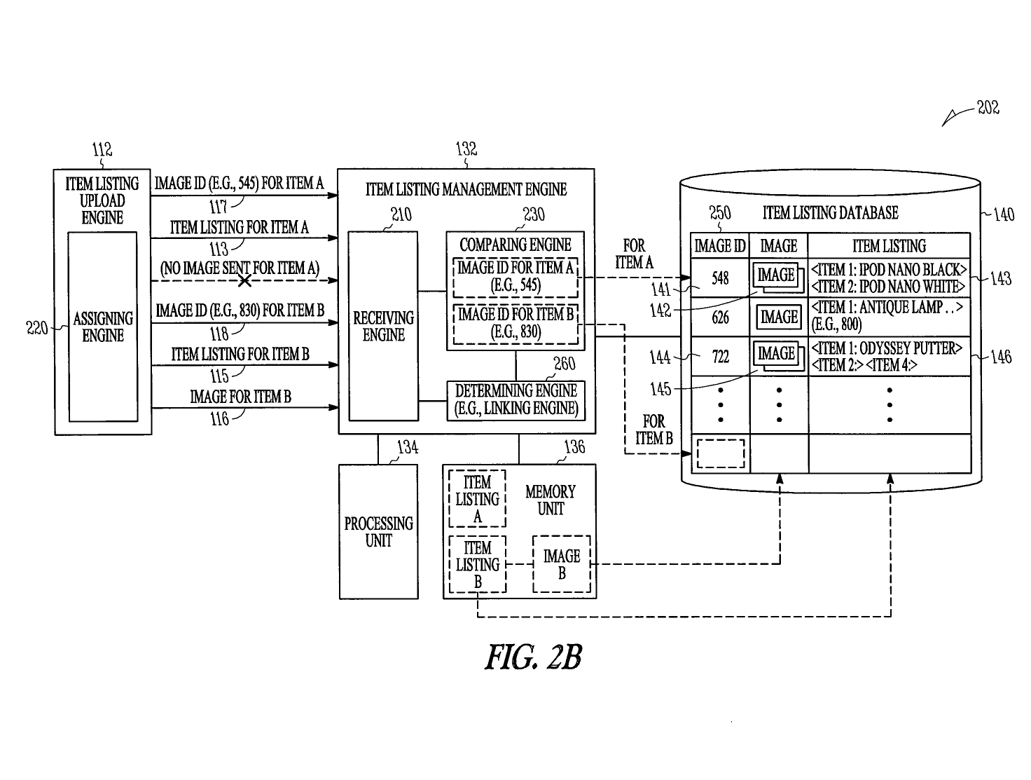

The host device 130 may run an item listing management engine 132, a memory unit 136 and a processing unit 134. The item listing management engine 132 may receive the item listing and/or the image for the item listing transferred from any of the user devices 110-1 through 110-N. The memory unit 136 may store the received item listing and/or the received image for the item listing for further processing by the processing unit 134. The item listing management engine 132 may assign an image identifier to the image transferred from the user device 110-1 and compare the image identifier with one or more image identifiers existing in the host device 130. Each of the one or more existing image identifiers may be associated with an existing item image stored in the host device 130. If the comparing is done, the item listing management engine 132 may further link the received item listing to an item image according to a result of the comparing. More detailed explanation about the item listing management engine 132 is given below using FIGS. 2A and 2B. In some example embodiments, one or more existing item images (e.g., 147, 148 and 149) may reside in an item listing database 140 which may be operatively coupled to the host device 130 locally, or remotely via the network 120 or a distinct network (not shown in FIG. 1).

FIG. 2A is a diagram of a computer system for managing item listings 201 in accordance with an example embodiment. Illustrated in FIG. 2A are the item listing upload engine 112, the item listing management engine 132 operatively coupled with the processing unit 134 and the memory unit 136, and the item listing database 140 having an item listing table 250 therein. Item listings (e.g., an item listing for item A 113 and an item listing for item B 115) and images associated with the item listings (e.g., an image for the item A 114 and an image for the item B 116) may be uploaded from the item listing uploading engine 112 to the item listing management engine 132. In some example embodiments, the item listings 113, 115 and the corresponding images 114, 116 may be stored in the memory unit 136 for further processing by the processing unit 134. The item listing management engine 132 may include a receiving engine 210, an assigning engine 220, a comparing engine 230 and a linking engine 240. For example, if the item listing for the item A 113 and the image for the item A 114 are uploaded from the item listing uploading engine 112, the receiving engine 210 may receive the item listing for the item A 113 and the image for the item A 114.

In response to the receipt, the assigning engine 220 may assign an image identifier to each image for the items A 114 and B 116. In some example embodiments, the image identifier may be generated as a function of a hash algorithm, such as MD5 or SHA-1. In some example embodiments, other suitable hash algorithms may be used to generate an image identifier. The image identifier may be a binary value that can be converted to an integer value. For example, a numerical value “545” and “830” may be assigned to the image for the item A 114 and the image for the item B 116, respectively as an image identifier. In some example embodiments, the assigning engine 220 may only generate a distinguishable part of the image identifier. In such a case, the distinguishable part may be combined with one or more other numerical values indicating, for example, a location of storage or category information of a corresponding item to produce a complete image identifier. For example, “160116111548808038”, “1601161116268080” and “1601161117228080” may be produced as image identifiers.

The comparing engine 230 may then refer to the item listing table 250 in the item listing database 140 and identify an image identifier that is identical or substantially identical to the image identifier (e.g., 545) assigned to the image for the item A 114 transferred from the item listing upload engine 112. In some example embodiments, an image identifier may be treated as being substantially identical to another image identifier if the value of the image identifier is within a predefined threshold difference (e.g., 2, 5, 10, 20, 50, 100 or 120, etc.) from a value of the other image identifier. For example, there is no existing image identifier having the value of “545” in the item listing table 250. An existing image identifier 141 having the value of “548” may be, however, recognized as being substantially identical to the image identifier (e.g., “545”) assigned to the image for the item A 114 if a value of “5” is set as the threshold difference.

The linking engine 240 then may discard the image for the item A 114 (e.g., from the memory unit 136) and link the item listing for the item A 113 to an existing image 142 via the existing image identifier 141 (e.g., “548”). In some embodiments, the item listing for the item A 113 may be inserted in the item listing table 250 as one of “item listings” 143 associated with the existing image identifier 141.

The comparing engine 230 may, however, fail to find an existing image identifier that matches (e.g., is identical or substantially identical to) the image identifier (e.g., “830”) for the image for the item B 116. In some example embodiments, the linking engine 240 then may link the item listing for the item B 115 with the image for the item B 116 and store them together into the item listing table 250 as a new row along with the newly assigned image identifier (e.g., “830”). It is noted that the image identifier (e.g., “830”) for the image for the item B 116 may be regarded as substantially identical to an existing image identifier 144 with a value of “722” if a value larger than the difference between “830” and “722” (e.g., “120”) is set as the predefined threshold value. As similarly described above, the linking engine 240 may then discard the image for the item B 116 that may have been temporarily stored in the memory unit 136 and link the item listing for the item B 115 to an existing image 145 via the existing image identifier 144 (e.g., “722”). In some example embodiments, the item listing for the item B 115 may be inserted in the item listing table 250 as one of “item listings” 146 associated with the existing image identifier 144. It is noted that each of the engines described above in FIG. 2A may be implemented by hardware (e.g., circuit), firmware, software or any combinations thereof. It is also noted that although each of the engines is described above as a separate module, the entire engines or some of the engines in FIG. 2A may be implemented as a single entity (e.g., module or circuit) and still maintain the same functionality.

FIG. 2B is a diagram of a computer system for managing item listings 202 in accordance with an example embodiment. Illustrated in FIG. 2B are the item listing uploading engine 112, the item listing management engine 132 operatively coupled with the processing unit 134 and the memory unit 136, and the item listing database 140 having the item listing table 250 therein. In this example embodiment, the item listing uploading engine 112 may include the assigning engine 220. The assigning engine 220 may be downloaded from the host device 130 via the network 120 to the user device (e.g., 110-1) and installed in the user device (e.g., 110-1) to generate an image identifier for a given item image provided by a user. More detailed explanation about the item listing uploading engine 112 is given below using FIG. 3. It is noted that each of the engines described above may be implemented by hardware (e.g., circuit), firmware, software or any combination thereof. It is also noted that although each of the engines is described above as a separate module, the entire engines or some of the engines may be implemented as a single entity (e.g., module or circuit) and still maintain the same functionality.

In some example embodiments, an image identifier (e.g., “545”) for an item A 117 may be transferred from the item listing uploading engine 112 to the item listing management engine 132. As described above in FIG. 2A, the image identifier may be generated as a function of a hash algorithm, such as MD5 or SHA-1. The item listing management engine 132 may include a receiving engine 210, a comparing engine 230 and a determining engine 260. If the image identifier (e.g., “545”) for the item A 117 transferred from the item listing uploading engine 112 is received by the receiving engine 210, the comparing engine 230 may compare the image identifier (e.g., “545”) with one or more existing image identifiers for existing images. In some example embodiments, the existing images and the existing image identifiers thereof may be stored in the item listing table 250 in the item listing database 140.

As described above in FIG. 2A, although there is no exactly identical image identifier in the item listing table 250, an existing image identifier (e.g., “548”) 141 may be regarded as being substantially identical to the image identifier (e.g., “545”) for the item A 117 if the predefined threshold difference is equal to or larger than three (e.g., “5”). The determining engine 260 then may receive an item listing for the item A 113 from the item listing uploading engine 112. The determining engine 260 then may further link the received item listing for the item A 113 with an existing image 142 via the substantially identical existing image identifier (e.g., “548”) 141. The item listing for the item A 113 may be inserted in the item listing table 250 as one of “item listings” 143 associated with the existing image identifier 141. It is noted, however, that the image for the item A may not be uploaded from the item listing uploading engine 112 to the item listing management engine 132.

When another image identifier (e.g., “830”) for an item B 118 transferred from the item listing uploading engine 112 is received by the receiving engine 210 of the item listing management engine 132, the comparing engine 230 may compare the image identifier (e.g., “830”) for the item B 118 with one or more image identifiers stored in the item listing table 250. This time, however, the comparing engine 230 may fail to find an existing image identifier that matches (e.g., is identical or substantially identical to) the image identifier (e.g., “830”) for the item B 118. The determining engine 260 then may receive the item listing for the item B 115 and the image for the item B 116 from the item listing uploading engine 112. The determining engine 260 may further store them together into the item listing table 250 as a new row along with the newly assigned image identifier (e.g., “830”). As described above in FIG. 2A, it is noted that the image identifier (e.g., “830”) for the image for the item B 116 may be regarded as substantially identical to the existing image identifier 144 with a value of “722” if a value larger (e.g., “120”) than the difference between “830” and “722” is set as the predefined threshold difference. Then, the determining engine 260 may not receive the image for item B 116. Instead, the determining engine 260 may link the item listing for the item B 115 to an existing image 145 via the existing image identifier (e.g., “722”) 144.

As similarly described above, in some embodiments, the item listing for the item B 115 may be inserted in the item listing table 250 as one of “item listings” 146 associated with the existing image identifier 144. In some example embodiments, the item listings 113, 115 may be uploaded from the item listing uploading engine 112 to the item listing management engine 132 when their corresponding image identifiers 117, 118 are transferred. In such a case, the uploaded item listings 113, 115 may be temporarily stored in the memory unit 136 for further processing by the processing unit 134. In some example embodiments, the determining engine 260 may be the same linking engine 240 as described above in FIG. 2A. It is noted that each of the engines described above in FIG. 2B may be implemented by hardware (e.g., circuit), firmware, software or any combinations thereof. It is also noted that although each of the engines is described above as a separate module, the entire engines or some of the engines in FIG. 2B may be implemented as a single entity (e.g., module or circuit) and still maintain the same functionality. Although FIGS. 2A and 2B describe managing only a single image for an item listing, in some example embodiments, a plurality of images for the item listing may be managed and thus associated with the item listing using a similar method. In such a case, the item listing management engine 132 may similarly reiterate some or entire processes described above for each of the plurality of images for the item listing.

FIG. 3 is a diagram of a computer system for uploading item listings 300 in accordance with an example embodiment. Illustrated in FIG. 3 is the item listing upload engine 112. The item listing uploading engine 112 may include a providing engine 310, an assigning engine 320, a transferring engine 330 and a receiving engine 340. The providing engine 310 may receive item listings and images for the item listings from a user. For example, the item listing for the item A 113 and the image for the item A 114 may be provided by the user via a user interface (not shown in FIG. 3), such as a mouse, keyboard, electronic pen, associated with the user device 110-1 executing the item listing uploading engine 112. In some example embodiments, the item listings 113, 115 and the corresponding images 114, 116 may be temporarily stored in the memory unit 111-1 for further processing by the processing unit 111-2. The assigning engine 320 may assign the image identifiers (e.g., “545”) 117, (e.g., “830”) 118 to the image for the item A 114 and the image for the item B 116, respectively. In some example embodiments, the image identifiers 117, 118 may be generated by an image identifier generating engine distributed from the host device 130.

The transferring engine 330 may transfer, for example, the image identifier (e.g., “545”) 117 to the host device 130. The host device 130 may then compare the image identifier 117 with one or more existing image identifiers for existing images stored in the host device 130 as described above in FIGS. 2A and 2B. The receiving engine 340 then may wait for and receive a result of the comparing 352 from the host device 130. The result of the comparing 352 may indicate whether there is an existing image identifier in the host device 130 that matches (e.g., is identical or substantially identical to) the image identifier (e.g., “545”) for the item A 117 sent to the host device 130. The transferring engine 330 then may upload the item listing for the item A 113 to the host device 130 for further processing. It is noted that the image for the item A 114 provided by the user may not be uploaded to the host device 130 since the result of the comparing 352 indicates that an identical or substantially identical image may exist in the host device 130. For the item listing for the item B 115 and the image for the item B 116, the image identifier (e.g., “830”) for the item B 118 assigned by the assigning engine 320 may be transferred to the host device 130. This time, the result of the comparing 354 returned from the host device 130 may indicate that there is no matching (e.g., identical or substantially identical) existing image identifier in the host device 130. The transferring engine 330 then may upload both the item listing for the item B 115 and the image for the item B 116 to the host device 130 for further processing. In some example embodiments, the item listings 113, 115 may be uploaded to the host device 130 when their corresponding image identifiers 117, 118 are transferred to the host device 130.

In some example embodiments, the transferring engine 330 may be further configured to send an override notification 360 to the host device 130. The override notification 360 may indicate that the image for the item A 114 will be transferred to the host device 130 regardless of the result of the comparing 352. If the host device 130 reviews and sends an allowance 370 back to the item listing uploading engine 112, the transferring engine 330 may upload the image for the item A 114 to the host device 130 even though the result of the comparing 352 indicates that an matching image identifier exits in the host device 130. In some example embodiments, the transferring engine 330 may send the image for the item A 114 without waiting for the allowance 370 from the host device 130. In some example embodiments, the host device 130 may be one of the other user devices 110-2 through 110-N. It is noted that each of the engines described above in FIG. 3 may be implemented by hardware (e.g., circuit), firmware, software or any combinations thereof. It is also noted that although each of the engines is described above as a separate module, the entire engines or some of the engines in FIG. 3 may be implemented as a single entity (e.g., module or circuit) and still maintain the same functionality. Although FIG. 3 describes uploading only a single image for an item listing, in some example embodiments, a plurality of images for the item listing may be uploaded to the host device 130 using a similar method. In such a case, the item listing uploading engine 112 may similarly reiterate some or entire processes described above for each of the plurality of images for the item listing.

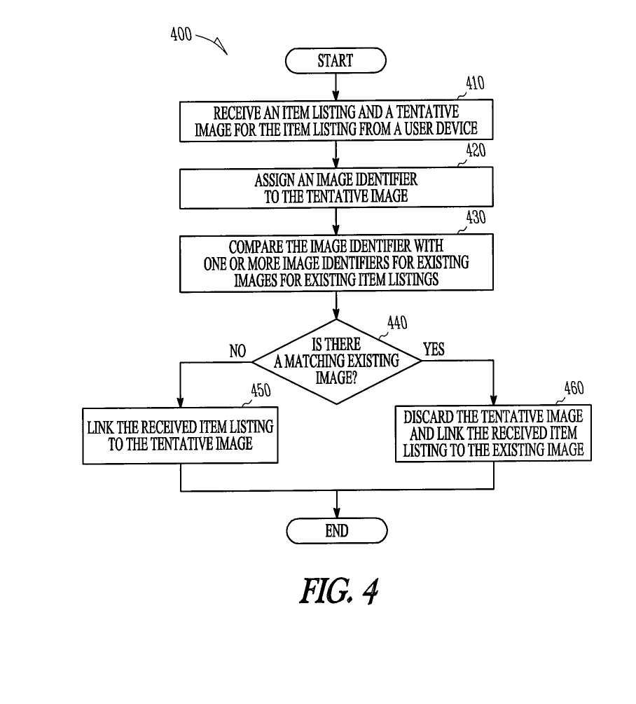

FIG. 4 is a flow chart illustrating a method used to manage item listings 400 in accordance with an example embodiment. At operation 410, an item listing for an item and a tentative image for the item listing may be received from a user device (e.g., 110-1). At operation 420, an image identifier may be assigned to the image received from the user device. The image identifier may be identical or substantially identical for the same or similar images, and unique for different images. At operation 430, the image identifier assigned to the image received from the user device (e.g., 110-1) may be compared with one or more image identifiers for existing images for item listings that exist in the host device 130. At operations 440-460, the item listing received from the user device (e.g., 110-1) may be linked to the tentative image according to a result of the comparing.

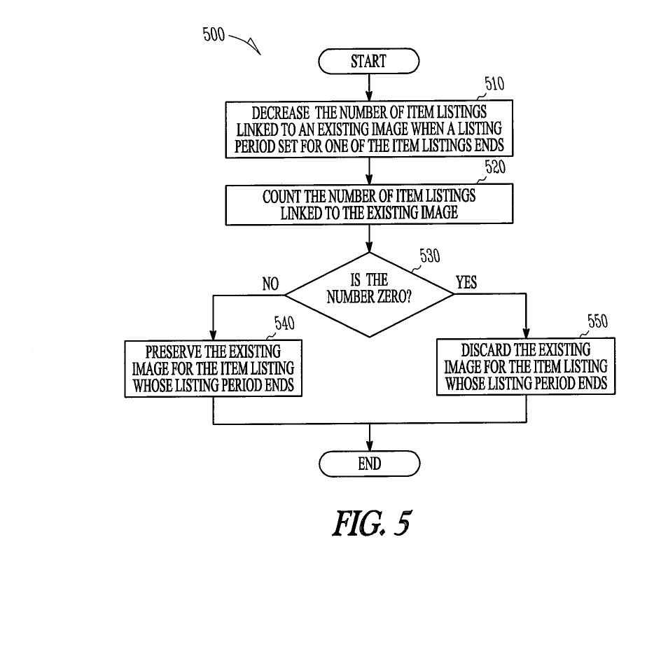

In some example embodiments, at operation 440, it may be checked whether there is an existing image in the host device 130 that matches the tentative image. This may be done by checking whether there is an image identifier in the host device 130 that matches (e.g., identical or substantially identical to) the image identifier assigned to the tentative image received from the user device (e.g., 110-1). If it is determined that there is no matching image in the host device, at operation 450, the item listing and the tentative image received from the user device (e.g., 110-1) may be linked to each other and stored together in the host device 130 along with the image identifier assigned to the image. If it is determined that the image identifier assigned to the image received from the user device (e.g., 110-1) matches an existing image, at operation 460, the tentative image may be discarded from the host device 130. The item listing received from the user device (e.g., 110-1) then may further be linked to the existing image in the host device 130. In some example embodiments, the item listing and the image for the item listing may be stored in an item listing database (e.g., 140) that may be locally or remotely coupled to the host device 130. In some embodiments, the image identifier may be generated as a function of a hash algorithm, such as MD5 or SHA-1. In some example embodiments, a listing period may be set for the item listing received from the user device (e.g., 110-1). The listing period may be used to mange existing item images as described below in more detail using FIG. 5.

FIG. 5 is a flow chart illustrating a method used to manage existing item images 500 in accordance with an example embodiment. At operation 510, the number of item listings may be decreased when a listing period set for a respective item listing ends. At operation 520, the number of item listings may be counted as decreased. At operation 530, it may be checked whether the number counted at operation 520 is zero. At operation 540, if it is determined that the counted number is not zero (i.e., equal to or larger than one), the existing image associated with the existing item listing whose listing period ends may be preserved. At operation 550, if it is determined that the counted number is zero, the existing image associated with the existing item listing whose listing period ends may be discarded.

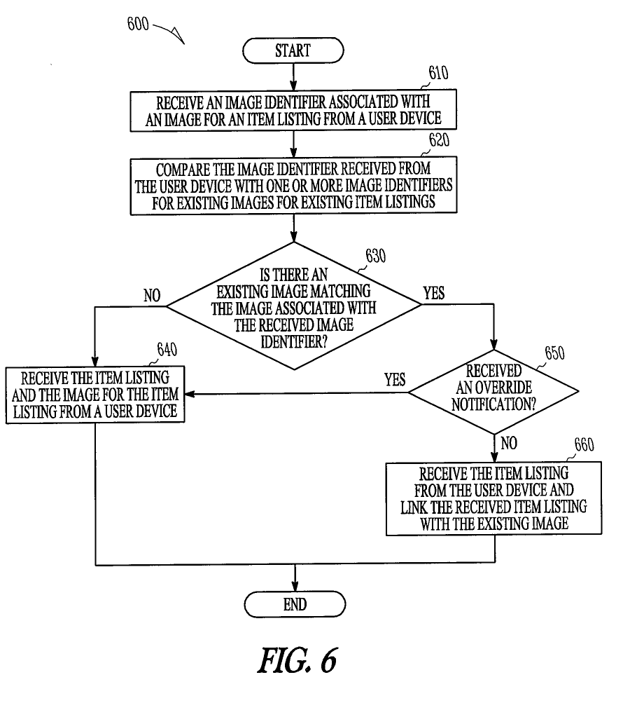

FIG. 6 is a flow chart illustrating a method used to receive an item listing from a user device 600 in accordance with an example embodiment. At operation 610, an image identifier associated with an image for an item listing may be received from a user device (e.g., 110-1). The image identifier may be identical or substantially identical for the same or similar images and unique for different images. In some example embodiments, the image identifier may be generated as a function of a hash algorithm, such as MD5 or SHA-1. At operation 620, the image associated with the image identifier may be compared with one or more existing images for existing item listings. This comparison may be done by comparing the image identifier received from the user device with one or more image identifiers for the one or more existing images for the existing item listings. At operation 630, it may be checked whether there is an existing image that matches (e.g., identical or substantially identical to) the image associated with the image identifier received from the user device. At operation 640, if it is determined that there is no exiting image that matches the image associated with the image identifier received from the user device, then both the item listing and the image for the item listing may be received from the user device 110-1.

In contrast, if it is determined that there is an existing image that matches the image associated with the image identifier received from the user device 110-1, at operation 650, it may be further checked whether an override notification is received from the user device. The override notification may indicate that the image will be transferred from the user device regardless of the result of the comparing at operation 620. If it is determined that there is an override notification received from the user device, then the control goes back to operation 640, where both the item listing and the image for the item listing may be received from the user device. On the contrary, if it is determined that there is no override notification received from the user device, the control goes to operation 660. At operation 660, the item listing may be received from the user device and linked with the existing image that matches the image associated with the image received from the user device. In some example embodiments, the operation 650 may not be employed. In such a case, if is determined that there is an existing image that matches the image associated with the image identifier received from the user device, the control moves from operation 630 to operation 660.

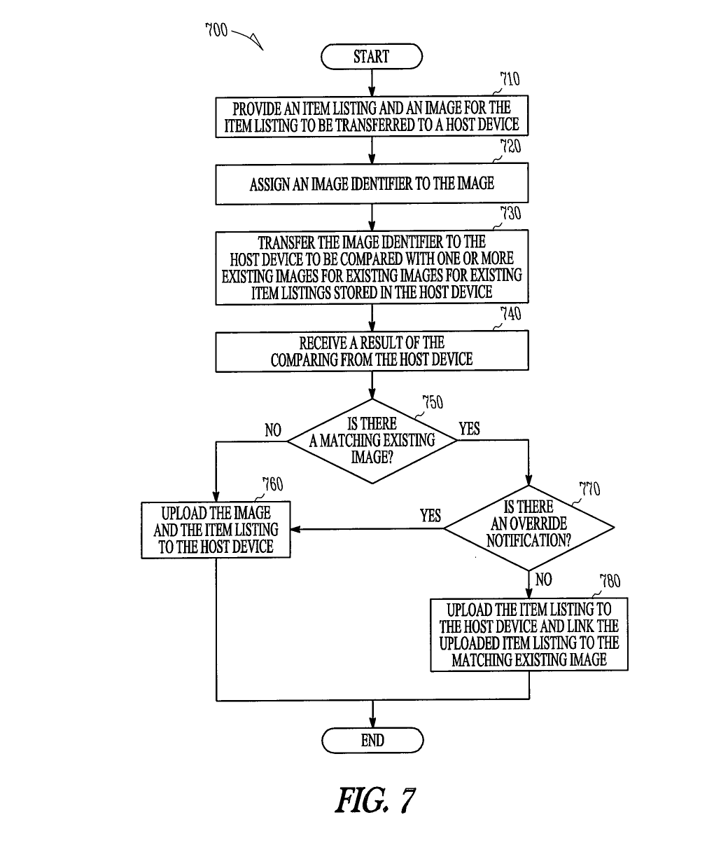

FIG. 7 is a flow chart illustrating a method used to upload an item listing to a host device 700 in accordance with an example embodiment. At operation 710, an item listing and an image for the item listing may be provided to be transferred to a host device (e.g., 130). In some example embodiments, the host device may be another user device (e.g., 110-2). At operation 720, an image identifier may be assigned to the image. The image identifier may be identical or substantially identical for the same or similar images and unique for different images. In some example embodiments, the image identifier may be generated by an image identifier generating engine distributed from the host device. The image identifier generating engine may use a hash algorithm, such as MD5 or SHA-1, etc. included therein. At operation 730, the image identifier may be transferred to the host device to be compared with one or more existing image identifiers stored in the host device. At operation 740, a result of the comparing may be received from the host device. At operation 750, it may be checked whether the result of the comparing received from the host device indicates that there is an existing image in the host device that matches (e.g., identical or substantially identical to) the image associated with the image identifier transferred to the host device. If it is determined that there is no matching existing image in the host device, then the control moves to operation 760. At operation 760, both the item listing and the image for the item listing may be uploaded to the host device.

In contrast, if it is determined at operation 750 that there is a matching existing image in the host device, the control moves to operation 770. At operation 770 it may be further checked whether an override notification is sent by the user device. If it is determined that the override notification is sent by the user device, the control goes back to operation 760, where both the item listing and the image for the item listing may be uploaded to the host device. On the contrary, if it is determined at operation 770 that no override notification is sent to the host device, the control moves to operation 780. At operation 780, the item listing may be uploaded to the host device without uploading the image for the item listing. The uploaded item listing may then be linked to the existing image that matches the image associated with the image identifier. In some example embodiments, at operation 770, it may be further checked whether the override notification sent to the host device is allowed by the host device. In such a case, even if an override notification is communicated to the host device, the image for the item listing is not uploaded to the host device if the override notification is not allowed by the host device. Instead, at operation 780, only the item listing may be uploaded to the host device and the uploaded item listing may be linked to the matching existing image. In some example embodiments, the operation 770 may not be employed. In such a case, if is determined that there is a matching existing image identifier in the host device, the control goes from operation 750 to operation 780. Although FIGS. 4-7 describe dealing with (e.g., uploading or associating with) only a single image for an item listing, in some example embodiments, a plurality of images for the item listing may be uploaded to the host device 130 and thus associated with the item listing. In such a case, some or all of the methods described above may be similarly reiterated for each of the plurality of images for the item listing.

### Example Database

Some example embodiments may include the various databases (e.g., item listing database 140) being relational databases or in some example cases On Line Analytic Processing (OLAP)-based databases. In the case of relational databases, various tables (e.g., 250) of data are created and data is inserted into, and/or selected from, these tables using SQL or some other database-query language known in the art. In the case of OLAP databases, one or more multi-dimensional cubes or hypercubes containing multidimensional data from which data is selected or into which data is inserted using MDX may be implemented. In the case of a database using tables and SQL, a database application such as, for example, MYSQL™, SQLSERVER™, Oracle 81™, 10G™, or some other suitable database application may be used to manage the data. Here, the case of a database using cubes and MDX, a database using Multidimensional On Line Analytic Processing (MOLAP), Relational On Line Analytic Processing (ROLAP), Hybrid On Line Analytic Processing (HOLAP), or some other suitable database application may be used to manage the data. These tables, or cubes made up of tables, in the case of, for example, ROLAP, are organized into a RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization and/or optimization algorithm known in the art.

FIG. 8 is a diagram illustrating a data structure for an item listing 800 in accordance with an example embodiment. The item listing may be a detailed description for a corresponding item. Illustrated in FIG. 8 are properties of serial number 810; title 820; tags 830 including category 832, color 834, and price 836; listing period 840; and image identifier 850. The serial number 810 may indicate the order of the item listing among one or more item listings that are linked to the same image via the same image identifier (e.g., 850). An integer data type may be used for the serial number 810. The title 820 may indicate the item's title (e.g., iPod Nano, Odyssey Putter, etc.). A string data type may be used for the title 820. The tags 830 may be other detailed information about the item. For example, the category 832 may indicate category of the item (e.g., electronics, sporting goods, books, antiques, etc.). A character data type may be used for the category 832. The color 834 may indicate the item's color and be represented using, for example, a character data type. The price 836 may indicate the item's price and may be represented using, for example, a floating point. The listing period 840 may indicate a period (e.g., May 13, 2008˜June 13, 2008, or 1 day, 2 days, 1 weeks, etc.) for the item listing to be displayed and be represented using, for example, a date data type. In some example embodiments, the listing period 840 may be combined with a time data type to represent an hour and/or minute as well. The image identifier 850 may indicate an image identifier to which the item listing is linked with. In some example embodiments, the image identifier 850 may be generated as a function of a hash algorithm and thus may be represented using, for example, an integer data type.

### A Three-Tier Architecture

In some example embodiments, a method is illustrated as implemented in a distributed or non-distributed software application designed under a three-tier architecture paradigm, whereby the various components of computer code that implement this method may be categorized as belonging to one or more of these three tiers. Some example embodiments may include a first tier as an interface (e.g., an interface tier) that is relatively free from application processing. Further, a second tier may be a logic tier that performs application processing in the form of logical/mathematical manipulations of data inputted through the interface level, and that communicates the results of these logical/mathematical manipulations to the interface tier and/or to a backend or storage tier. These logical/mathematical manipulations may relate to certain business rules or processes that govern the software application as a whole. A third storage tier may be a persistent storage medium or non-persistent storage medium. In some example cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as may be discussed below, a variety of technologies. This three-tier architecture, and the technologies through which it is implemented, may be executed on two or more computer systems organized in a server-client, peer-to-peer, or some other suitable configuration. Further, these three tiers may be distributed between more than one computer system as various software components.

### Component Design

Some example embodiments may include the above illustrated tiers and the processes or operations that make them up, as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component-oriented or object-oriented programming technique can be implemented using a Visual Component Library (VCL), Component Library for Cross Platform (CLX), JavaBeans (JB), Enterprise JavaBeans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls used to implement one or more of the above-illustrated components across a distributed programming environment as distributed computing components. For example, an interface component (e.g., an interface tier) may reside on a first computer system remotely located from a second computer system containing a logic component (e.g., a logic tier). These first and second computer systems may be configured in a server-client, peer-to-peer, or some other suitable configuration. These various components may be written using the above-illustrated object-oriented programming techniques, and can be written in the same programming language or a different programming language. Various protocols may be implemented to enable these various components to communicate regardless of the programming language used to write these components. For example, a component written in C++ may be able to communicate with another component written in the Java programming language using a distributed computing protocol such as a Common Object Request Broker Architecture (CORBA), a Simple Object Access Protocol (SOAP), or some other suitable protocol. Some example embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Some example embodiments may use the OSI model or TCP/IP protocol stack model for defining the protocols used by a network to transmit data. In applying these models, a system of data transmission between a server and client or between peer computer systems is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as the Internet, a Local Area Network (LAN), a Wide Area Network (WAN), or some other suitable network. In some example cases, “Internet” refers to a network of networks. These networks may use a variety of protocols for the exchange of data, including the aforementioned TCP/IP, and additionally Asynchronous Transfer Mode (ATM), Systems Network Architecture (SNA), or some other suitable protocol. These networks may be organized within a variety of topologies (e.g., a star topology) or structures.

### A Computer System

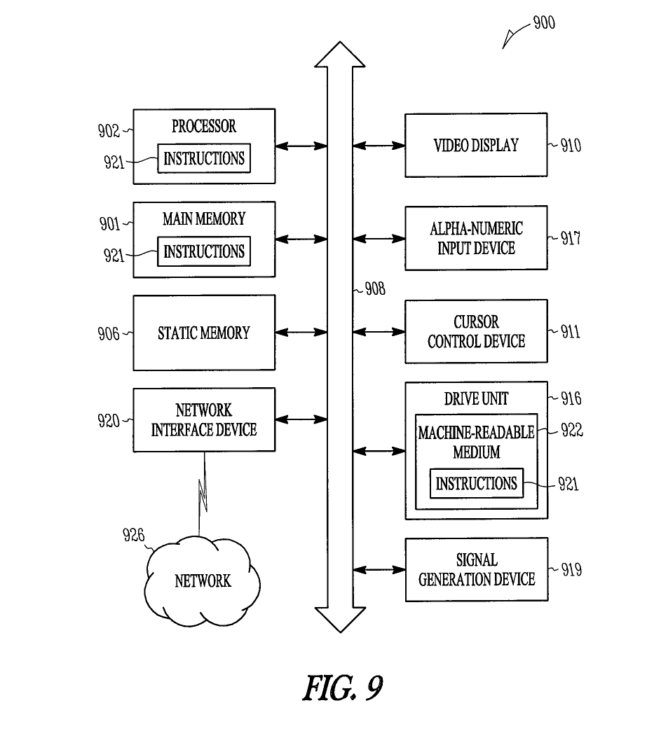

FIG. 9 is a diagram showing an example computer system 900 that executes a set of instructions to perform any one or more of the methodologies discussed herein. In some example embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The computer system 900 includes a processor 902 (e.g., a Central Processing Unit (CPU), a Graphics Processing Unit (GPU) or both), a main memory 901, and a static memory 906, which communicate with each other via a bus 908. The computer system 900 may further include a video display 910 (e.g., a Liquid Crystal Display (LCD) or a Cathode Ray Tube (CRT)). The computer system 900 also includes an alpha-numeric input device 917 (e.g., a keyboard), a User Interface (UI) cursor controller device 911 (e.g., a mouse), a drive unit 916, a signal generation device 919 (e.g., a speaker) and a network interface device (e.g., a transmitter) 920.

The drive unit 916 includes a machine-readable medium 922 on which is stored one or more sets of instructions and data structures (e.g., software) 921 embodying or used by any one or more of the methodologies or functions illustrated herein. The software 921 may also reside, completely or at least partially, within the main memory 901 and/or within the processor 902 during execution thereof by the computer system 900, the main memory 901 and the processor 902 also constituting machine-readable medium 922.

The software 921 may further be transmitted or received over a network 926 via the network interface device 920 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Marketplace Applications

Some example embodiments may include a system and method to link item images to item listings. The system and method include receiving an item listing and an image for the item listing from a user device. The system and method include assigning an image identifier to the image received from the user device. The image identifier may be identical or substantially identical for the same or similar images and unique for different images. The system and method include comparing the image identifier with one or more existing image identifiers. The system and method further include linking the received item listing to an image according to a result of the comparing.

Some example embodiments may include a system and method to receive item images for item listing. The system and method include receiving an image identifier associated with an image for an item listing from a user device. The image identifier may be identical or substantially identical for the same or similar images and unique for different images. The system and method include comparing the image identifier received from the user device with one or more existing image identifiers. The system and method further include determining whether to receive the image from the user device according to a result of the comparing.

### Additional Notes

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media such as during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above “DETAILED DESCRIPTION” includes references to the accompanying drawings, which form a part of the “DETAILED DESCRIPTION.” The drawings show, by way of illustration, some example embodiments. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description with each claim standing on its own as a separate embodiment.

What is claimed is:

1. A computer-implemented method, comprising:
receiving an item listing and a tentative image for the item listing from a user device;
assigning an image identifier to the tentative image, the image identifier being substantially identical for similar images and unique for different images;
comparing the image identifier with one or more image identifiers for existing images for existing item listings; and
linking the received item listing to the tentative image according to a result of the comparing.

2. The computer-implemented method of claim 1, wherein the linking the received item listing to the tentative image further comprises:
if the result indicates that the tentative image does not match any of the existing images, then linking the received item listing to the tentative image; and
if the result indicates that the tentative image matches an existing image, then discarding the tentative image and linking the received item listing to the existing image.

3. The computer-implemented method of claim 1, wherein the assigning of the image identifier further comprises assigning the image identifier as a function of a hash algorithm.

4. The computer-implemented method of claim 1, wherein the receiving of the item listing further comprises setting a listing period for the received item listing.

5. The computer-implemented method of claim 4, further comprising discarding an existing image as a function of the number of item listings linked to the existing image, wherein the discarding of the existing image includes:
decreasing the number of item listings for each instance when a listing period set for an item listing ends;
counting the number of item listings; and
discarding the existing image if the number of item listings is zero.

6. A computer-implemented method, comprising:
receiving an image identifier associated with an image for an item listing from a user device, the image identifier being substantially identical for similar images and unique for different images;
comparing the image identifier received from the user device with one or more image identifiers for existing images for existing item listings; and
determining whether to receive the image for the item listing from the user device according to a result of the comparing.

7. The computer-implemented method of claim 6, further comprising sending the result of the comparing to the user device, the result indicating whether the image associated with the image identifier matches any of the existing images.

8. The computer-implemented method of claim 6, wherein the determining whether to receive the image from the user device further comprises:
if the result indicates that the image does not match any of the existing images, then receiving the item listing and the image for the item listing from the user device; and
if the result indicates that the image matches an existing image, then receiving the item listing from the user device and linking the received item listing with the existing image.

9. The computer-implemented method of claim 6, further comprising:
receiving an override notification from the user device, the override notification indicating that the image is to be transferred regardless of the result of the comparing; and
receiving the image from the user device.

10. A computer-implemented method, comprising:
providing an item listing and an image for the item listing to be transferred to a host device;
assigning an image identifier to the image, the image identifier being substantially identical for similar images and unique for different images;
transferring the image identifier to the host device to be compared with one or more image identifiers for existing images for existing item listings stored in the host device;
receiving a result of the comparing from the host device; and
uploading the image to the host device according to the result of the comparing.

11. The computer-implemented method of claim 10, wherein the uploading of the image to the host device further comprises:
if the result indicates that the image does not match any of the existing images, then uploading the image and the item listing to the host device; and
if the result indicates that the image matches an existing image, then uploading the item listing to the host device and linking it to the existing image.

12. The computer-implemented method of claim 11, further comprising:
sending an override notification to the host device, the override notification indicating that the image is to be transferred regardless of the result of the comparing; and
transferring the image to the host device.

13. The computer-implemented method of claim 10, wherein the image identifier is generated by an image identifier generating engine distributed from the host device.

14. The computer-implemented method of claim 10, wherein the host device is another user device.

15. A computer system, comprising:
a receiving engine to receive an item listing and a tentative image for the item listing from a user device;
an assigning engine to assign an image identifier to the tentative image, the image identifier being substantially identical for similar images and unique for different images;
a comparing engine to compare the image identifier with one or more image identifiers for existing images for existing item listings; and
a linking engine to link the received item listing to the tentative image according to a result of the comparing.

16. The computer system of claim 15, wherein the linking engine is further configured to:
if the result indicates that the tentative image does not match any of the existing images, then link the received item listing to the received tentative image; and
if the result indicates that the tentative image matches an existing image, then discard the tentative image and link the received item listing to the existing image.

17. The computer system of claim 15, wherein the assigning engine is further configured to assign the image identifier as a function of a hash algorithm.

18. The computer system of claim 15, wherein the receiving engine is further configured to set a listing period for the received item listing.

19. The computer system of claim 18, wherein the linking engine is further configured to discard an existing image as a function of the number of item listings linked to the existing image, the discarding comprising:
decreasing the number of item listings for each instance when a listing period set for an item listing ends;
counting the number of item listings; and
discarding the existing image if the number of item listings is zero.

20. A computer system, comprising:
a receiving engine to receive an image identifier associated with an image for an item listing from a user device, the image identifier being substantially identical for similar images and unique for different images;
a comparing engine to compare the image identifier received from the user device with one or more image identifiers for existing images for existing item listings; and
a determining engine to determine whether to receive the image from the user device according to a result of the comparing.

21. The computer system of claim 20, wherein the comparing engine is further configured to send the result of the comparing to the user device, the result indicating whether the image associated with the image identifier matches any of the existing images.

22. The computer system of claim 20, wherein the determining engine is further configured to:
if the result indicates that the image does not match any of the existing images, then receive the item listing and the image for the item listing from the user device; and
if the result indicates that the image matches an existing image, then receive the item listing from the user device and link the received item listing with the existing image.

23. The computer system of claim 22, wherein the determining engine is further configured to:
receive an override notification from the user device, the override notification indicating that the image is to be transferred regardless of the result of the comparing; and
receive the image from the user device.

24. A computer system, comprising:
a providing engine to provide an item listing and an image for the item listing to be transferred to a host device;
an assigning engine to assign an image identifier to the image, the image identifier being substantially identical for similar images and unique for different images;
a transferring engine to transfer the image identifier to the host device to be compared with one or more image identifiers for existing images for existing item listings stored in the host device;
a receiving engine to receive a result of the comparing from the host device; and
an uploading engine to upload the image for the item listing to the host device according to the result of the comparing.

25. The computer system of claim 24, wherein the uploading engine is further configured to:
if the result indicates that the image does not match any of the existing images, then upload the image and the item listing to the host device; and
if the result indicates that the image matches an existing image, then upload the item listing to the host device and linking it to the existing image.

26. The computer system of claim 25, wherein the transferring engine is further configured to:
send an override notification to the host device, the override notification indicating that the image is to be transferred regardless of the result of the comparing; and
transfer the image to the host device.

27. The computer system of claim 24, wherein the image identifier is generated by an image identifier generating engine distributed from the host device.

28. The computer system of claim 24, wherein the host device is another user device.

29. An apparatus, comprising:
means for receiving an item listing and a tentative image for the item listing from a user device;
means for assigning an image identifier to the tentative image, the image identifier being substantially identical for similar images and unique for different images;
means for comparing the image identifier with one or more image identifiers for existing images for existing item listings; and
means for linking the received item listing to the tentative image according to a result of the comparing.

30. A computer-readable medium having instructions stored thereon that, when executed by a computer, cause the computer to:
receive an item listing and a tentative image for the item listing from a user device;
assign an image identifier to the tentative image, the image identifier being substantially identical for similar images and unique for different images;
compare the image identifier with one or more image identifiers for existing images for existing item listings; and
link the received item listing to the tentative image according to a result of the comparing.
